(19) United States
(12) Patent Application Publication
(10) Pub. No.: US 2009/0288590 A1
(43) Pub. Date: Nov. 26, 2009

(54) Device For Flagging Items Lost in Snow

(76) Inventor: Ronald M. Pasquini, Louisville, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 12/470,904

(22) Filed: May 22, 2009

Related U.S. Application Data
(60) Provisional application No. 61/128,653, filed on May 23, 2008.

(51) Int. Cl. A63C 11/00; G01D 21/00

(52) U.S. Cl. 116/209

(57) ABSTRACT

A device for flagging an object buried in the snow includes a flag housed in a pouch, and held within the pouch by a closure mechanism such as a snap closure or a hook-and-loop closure. The flag is attached to a tether by means of an encircling element that passes around the closure mechanism (for example the encircling element could comprise a loop on the pouch end of the tether). As the encircling element is tugged on sharply, it forces the closure mechanism open, which allows the flag to exit the pouch, unfurling as it goes. The flag is attached via the tether to the object to be flagged, such as a ski, while the pouch remains fastened to a base object such as a ski boot. The system may also be used to locate avalanche victims, in which case the flag is attached to the person, thus providing a visual clue to the location of the victim buried below the surface of the avalanche.

### BACKGROUND OF THE INVENTION

1. Field of the Invention

The present invention relates to apparatus for flagging items which become buried in snow. In particular, the present invention relates to apparatus for flagging skis lost in powder snow or people buried in avalanches.

2. Description of the Related Art

Skiers, especially when skiing in deep powder snow, have long had problems finding their skis when they release in a fall. A skier probing the snow with a ski pole searching for a lost ski is a common sight at ski areas. While a ski lost at a ski area may be inconvenient, a ski lost in the backcountry wilderness can be catastrophic because travel back to safety through deep snow can be exhausting without the aid of skis. Despite the spring loaded pronged brakes on modern ski bindings which are meant to prevent the skis from traveling far after they release, the ski's momentum often causes the ski to burrow beneath deep powder snow some distance from the skier before it comes to a stop. Short, fixed length leashes connecting the ski to the skier's boot have been used in powder snow, but these have proved cumbersome and dangerous when a ski releases, as the ski flies around in the vicinity of the skier during a fall, possibly causing injury. In addition, backcountry skiers traveling in avalanche terrain shun the use of fixed ski leashes for fear of the tethered ski acting as an “anchor,” drawing a skier caught in an avalanche deeper beneath the surface.

Attempts have been made to flag skis as well. For example, U.S. Pat. No. 4,919,452 teaches a device for tethering a foam ball to the ski and stuffing the foam ball into a zippered pouch attached to the skier's ski boot. When the ski detaches from the boot, the foam ball is pulled out of the pouch and expands to flag the ski. U.S. Pat. No. 5,058,524 and Published U.S. Pat. App. Ser. No. 2005/0236829 teach similar devices, except they release a long ribbon to flag the ski when the ski detaches from the skiers boot.

Another serious problem is presented when a backcountry skier or other winter backcountry traveler (snowshoer, snowmobiler, dogsledder, snowboarder, etc.) is buried in an avalanche. The buried person must be located and rescued by other group members as quickly as possible. Various electronic transceiver beacons have been developed for this purpose and are used in conjunction with visual clues found at the surface, such as clothing, equipment, or even an exposed appendage of the victim.

Because of the potential for inconvenience at best and serious harm or death at worst when skis or people are lost beneath snow, and because of the limited number of practical options available, a need remains in the art for a device for flagging items or people lost in snow.

### SUMMARY

An object of the present invention is to provide a device for flagging items lost in snow. Such a device for flagging an item to be located when the item is lost in the snow comprises a pouch having an open end with a perimeter, a pouch closure element configured to releasably join two spaced-apart areas on the perimeter, an elongated flag configured for furling and insertion into the pouch, the flag having a connecting end and a loose end, the flag further configured to unfurl when released from the pouch, an encircling element connected to the connecting end of the flag, the encircling element configured to encircle the pouch closure when joined, and an attachment attaching the encircling element to the item to be located, wherein the pouch closure is further configured to release when a sharp tug is applied to the encircling element by the item to be located, such that the flag is released from the pouch.

For example, a long, brightly colored ribbon-like flag or streamer is attached to an encircling element at one end. The flag is then attached to the item to be located via a tether attached to the encircling element. The flag is inserted into a pouch. The pouch includes a closure mechanism to prevent the flag from falling out and unfurling under normal circumstances. The encircling element is disposed around the closure mechanism (for example a snap). When a sharp tug is applied to the encircling element, the encircling element pulls on the closure, and the closure is forced open, allowing the flag to exit from the pouch. Thus, when a ski, for example, attached to the flag releases from a ski boot attached to the pouch, the ski applies tension to the flag (via its encircling element) and detaches the pouch closure allowing the flag to escape the pouch and unfurl to its full length as it trails the ski.

Another example is when a backcountry skier is attached to the flag and his ski pole is attached to the pouch. If the skier is swept away by an avalanche, separating the skier from his ski poles, the flag will be pulled from the pouch and will trail the person. In either case, even if the object or person is buried beneath the snow and is no longer visible, the long, ribbon-like flag seen at the snow surface will lead directly to the object or person beneath the snow.

### BRIEF DESCRIPTION OF THE DRAWINGS

FIG. 1A is an exploded isometric view of a first embodiment of the present invention, wherein a tether spring hook and a flag loop connect the tether and the flag.

FIG. 1B is an isometric view of the embodiment of FIG. 1A, ready for use with the flag in the pouch, where the pouch is shown as transparent for clarity.

FIG. 1C is an isometric view of the embodiment of FIGS. 1A and 1B after the flag has been pulled from the pouch.

FIG. 2A is an exploded isometric view of a second embodiment of the present invention, wherein a tether spring hook and a flag ring connect the tether and the flag.

FIG. 2B is an isometric view of the embodiment of FIG. 2A, ready for use with the flag in the pouch, where the pouch is shown as transparent for clarity.

FIG. 2C is an isometric view of the embodiment of FIGS. 2A and 2B after the flag has been pulled from the pouch.

FIG. 3A is an exploded isometric view of a third embodiment of the present invention, wherein a small carabiner connects the tether and the flag.

FIG. 3B is an isometric view of the embodiment of FIG. 3A, ready for use with the flag in the pouch, where the pouch is shown as transparent for clarity.

FIG. 3C is an isometric view of the embodiment of FIGS. 3A and 3B after the flag has been pulled from the pouch.

FIG. 4A is an exploded isometric view of a fourth embodiment of the present invention, very similar to the embodiment of FIGS. 1A-C, except the pouch closure comprises a hook-and-loop fastener.

FIG. 4B is an isometric view of the embodiment of FIG. 4A, ready for use with the flag in the pouch, where the pouch is shown as transparent for clarity.

FIG. 4C is an isometric view of the embodiment of FIGS. 4A and 4B after the flag has been pulled from the pouch.

FIG. 5A is an exploded isometric view of a fifth embodiment of the present invention, as might be used as to flag a person buried in an avalanche, wherein a tether with wrist loop is directly attached to the flag.

FIG. 5B is an isometric view of the embodiment of FIG. 5A, ready for use with the flag in the pouch, where the pouch is shown as transparent for clarity.

FIG. 5C is an isometric view of the embodiment of FIGS. 5A and 5B after the flag has been pulled from the pouch.

### DETAILED DESCRIPTION OF THE PREFERRED EMBODIMENTS

The following reference numbers are used in the figures:

| | |
|---|---|
| 1 | Tether |
| 3 | Flag |
| 4 | Pouch |
| 5 | Snap closure |
| 7 | Fastening loop for pouch |
| 10 | Loop at distal end of tether |
| 11 | Loop at pouch end of tether |
| 12 | Attachment opening on flag |
| 13 | Tether spring hook |
| 14 | Flag loop |
| 15 | Flag ring |
| 16 | Small carabiner |
| 17 | Low profile fastening loop |
| 19 | Hook-and-loop closure |
| 22 | Tether wrist loop |

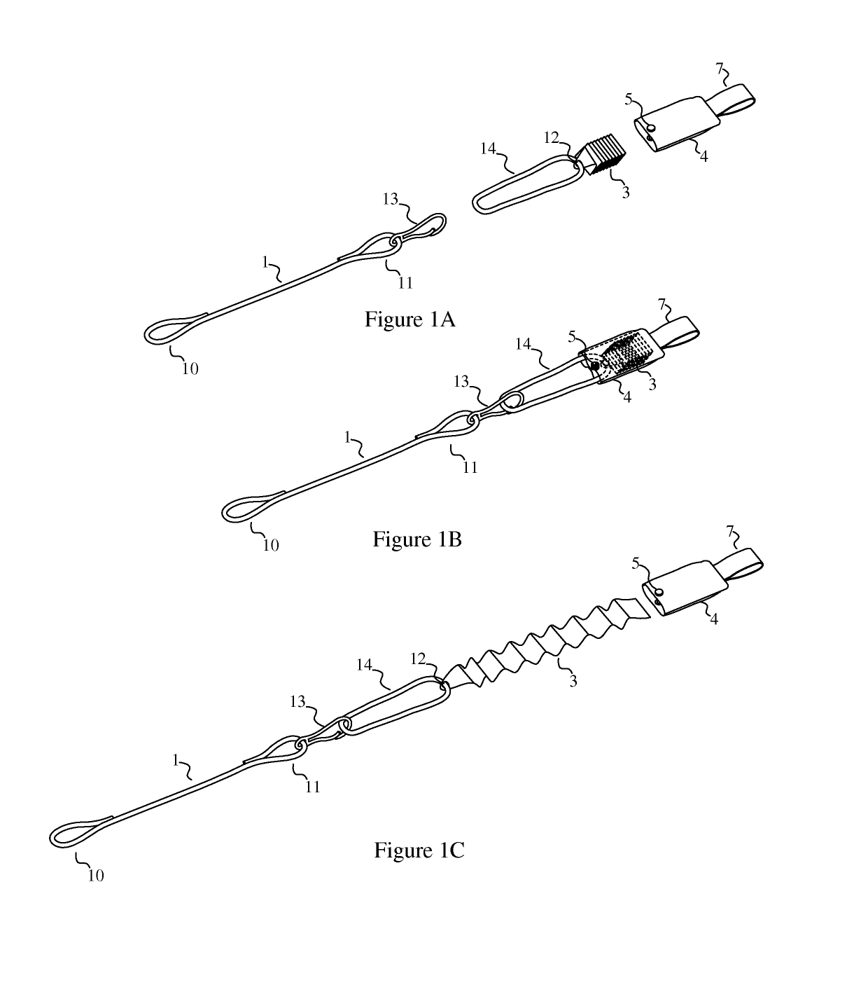

FIGS. 1A-5C illustrate various embodiments of the present invention. Each embodiment described below includes a flag 3 housed in a pouch 4, held within the pouch by a closure mechanism such as a snap closure 5 or a hook-and-loop closure 19. The closure mechanism releasably joins two spaced apart areas on the perimeter of the pouch opening. Flag 3 is attached to the item to be located by an attachment. For example, flag 3 is attached to tether 1 (which in turn attaches to the item to be located) by means of an encircling element that passes around the closure mechanism (for example the encircling element could comprise loop 11 on the pouch end of tether 1, flag loop 14, or flag ring 15). As the encircling element is tugged on sharply, it forces the closure mechanism open, which allows flag 3 to exit pouch 4, unfurling as it goes. The device may be reused by stuffing flag 3 back into pouch 4 and re-closing closure mechanism snap 5 or hook-and-loop 19. Or, the device may be disposable.

FIGS. 1A-C show a first embodiment of the present invention. FIG. 1A is an exploded isometric view showing the elements of the device wherein flexible flag loop 14 attaches to flag 3 by passing through an attachment opening 12 on the connecting end of flag 3. A tether spring hook 13 and a flag loop 14 connect the tether 1 and the flag 3. In this embodiment, flexible flag loop 14 is the encircling element which passes around the snap closure mechanism 5 on pouch 4 as shown in FIG. 1B. Tether 1 is attached to the item to be flagged, such as a ski, at distal end 10. Pouch 4 fastens to the base object, such as a ski boot, via a flat webbing loop 7. The spring hook 13 provides a convenient method of disconnecting tether 1 from flag 3, allowing easy separation, for example, between the ski portion of the device and the boot portion of the device when not powder skiing or for removal after skiing.

FIG. 1B is an isometric view of the embodiment of FIG. 1A, ready for use with the flag 3 in the pouch 4, where the pouch 4 is shown as transparent for clarity. Snap closure 5 is snapped closed, preventing flag 3 from coming out of pouch 4 in normal use. Tether 1 is attached to tether spring hook 13 at tether loop 11. Flag loop 14 attaches to one end of flag 3 at opening 12, and encircles closure 5. When flag loop 14 is yanked via its attachment to tether 1, it pops snap 5 open and flag 3 is then pulled from pouch 4. So in the example discussed above, when the ski releases from the ski boot, pouch 4 remains attached to the boot. Flag 3 is attached to the ski via flag loop 14, spring hook 13 and tether 1. While the ski is likely to be lost under the powder snow, flag 3 is long enough and lightweight enough that at least a portion of it will likely remain above the snow, flagging the ski for the skier to find.

FIG. 1C is an isometric view of the embodiment of FIGS. 1A and 1B after the flag has been pulled from the pouch. After snap 5 is pulled open by encircling flag loop 14, flag 3 is pulled out of pouch 4 by tether 1 via tether spring hook 13, and flag 3 unfurls as it exits pouch 4. Hence flag 3 in FIG. 1C is extended and available to flag the item to which it is tethered (such as a ski). Pouch 4, in turn, remains attached to the base object to which it is fastened (such as a ski boot), via flat webbing loop 7 or the like.

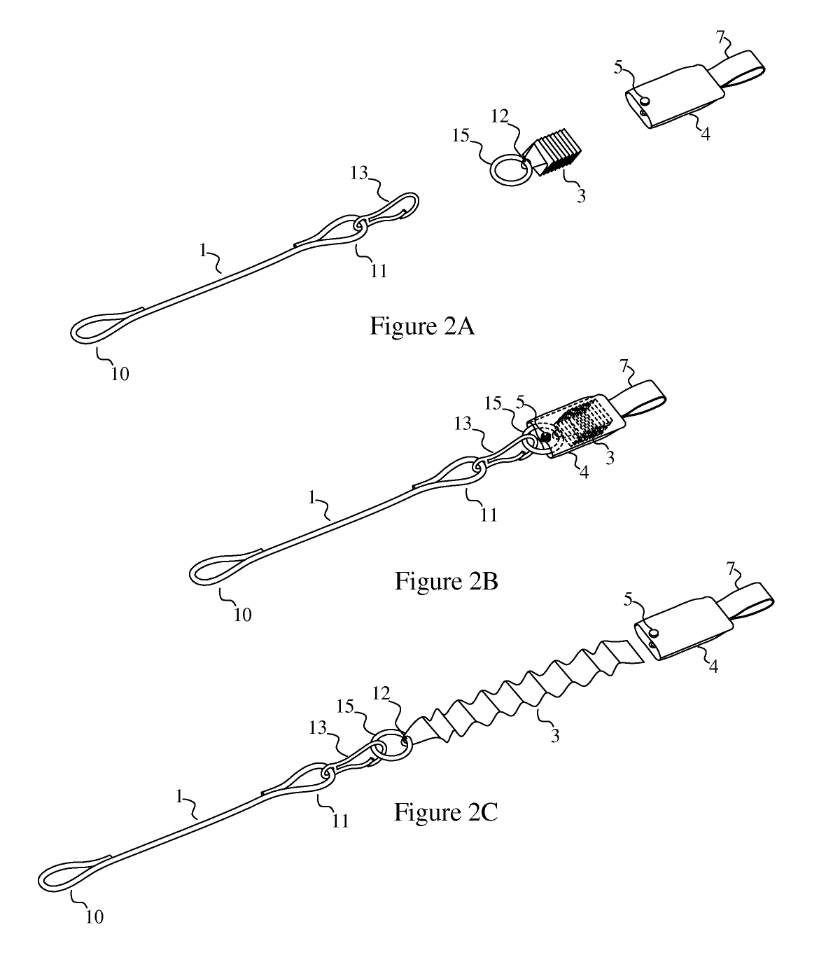

FIG. 2A is an exploded isometric view of a second embodiment of the present invention, wherein a tether spring hook 13 and a flag ring 15 connect the tether 1 to the flag 3. This embodiment is almost exactly like the embodiment of FIGS. 1A-C, except that rigid flag ring 15 replaces flexible flag loop 14.

Again, FIG. 2B is an isometric view of the embodiment of FIG. 2A, ready for use with the flag in the pouch, where the pouch is shown as transparent for clarity. FIG. 2C is an isometric view of the embodiment of FIGS. 2A and 2B after the flag has been pulled from the pouch.

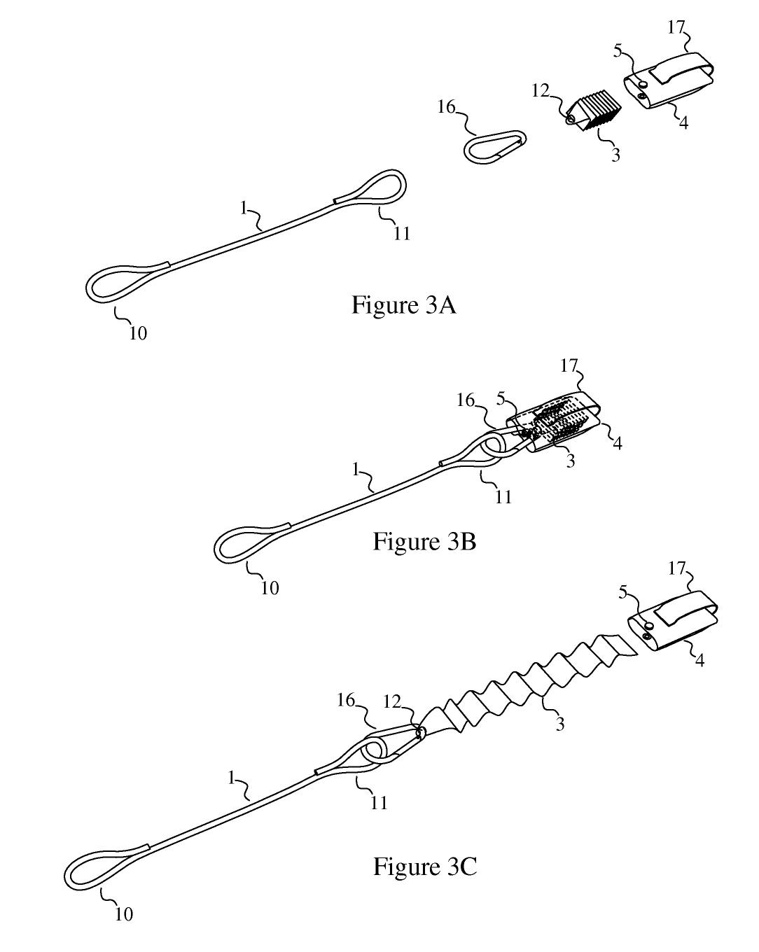

FIG. 3A is an exploded isometric view of a third embodiment of the present invention, wherein a small carabiner 16 connects the tether 1 and the flag 3 and also serves as the encircling element. In use, carabiner 16 is threaded through attachment opening 12 on flag 3 and then positioned such that the carabiner completely encircles the snap closure mechanism 5 as shown in FIG. 3B. Carabiners are particularly easy to operate while wearing winter gloves, allowing pouch end 11 of tether 1 to be quickly and easily detached and reattached as desired.

FIG. 3B is an isometric view of the embodiment of FIG. 3A, ready for use with the flag in the pouch, where the pouch is shown as transparent for clarity. FIG. 3C is an isometric view of the embodiment of FIGS. 3A and 3B after the flag has been pulled from the pouch. In this embodiment, pouch 4 fastens to the base object via low profile flat webbing loop 17.

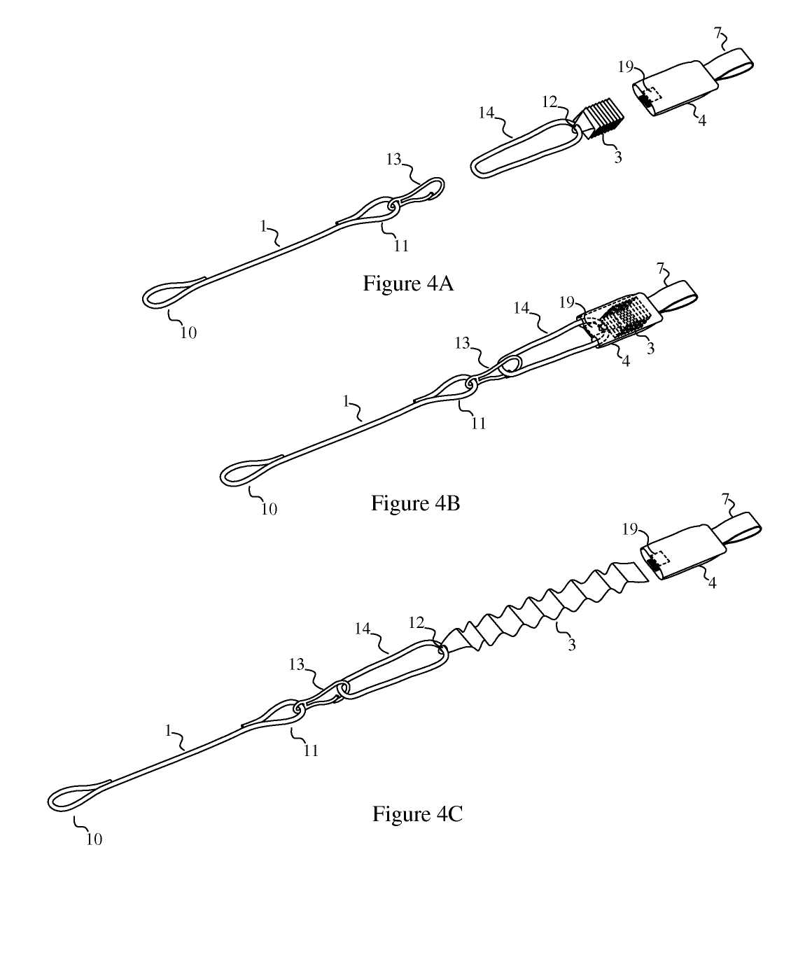

FIG. 4A is an exploded isometric view of a fourth embodiment of the present invention, very similar to the embodiment of FIG. 1A-C, except the pouch closure comprises a hook-and-loop closure 19, such as Velcro™. Flag loop 14 acts as the encircling element, and spring hook 13 allows separation of flag 3 and tether 1.

FIG. 4B is an isometric view of the embodiment of FIG. 4A, ready for use with the flag in the pouch, where the pouch is shown as transparent for clarity. FIG. 4C is an isometric view of the embodiment of FIGS. 4A and 4B after the flag has been pulled from the pouch.

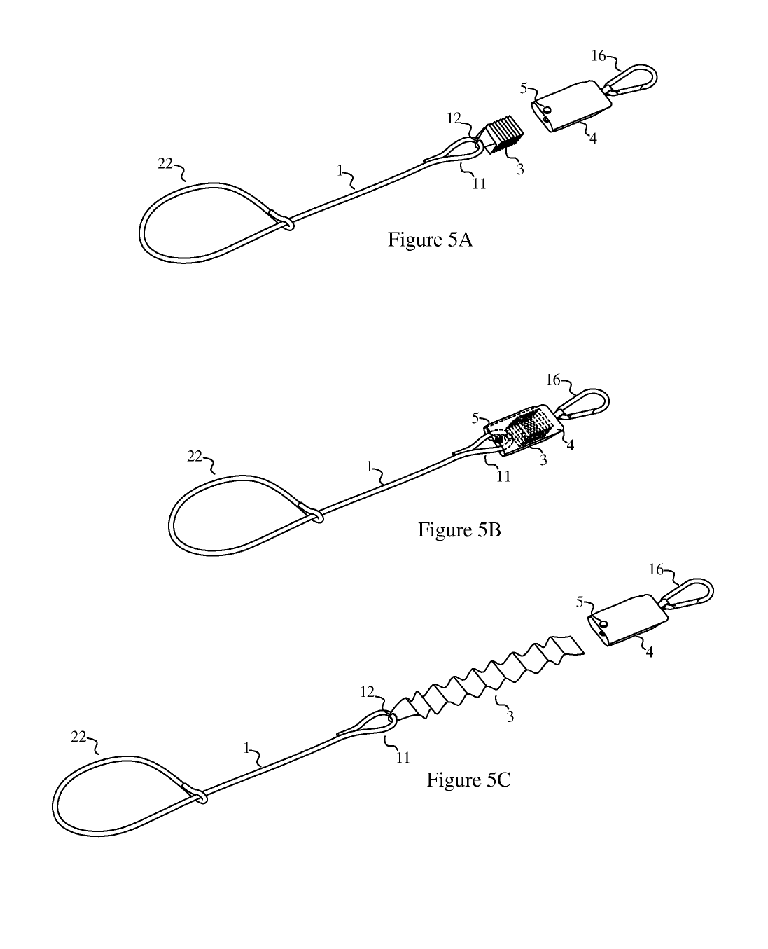

FIGS. 5A-C show a fifth embodiment of the present invention as might be used to flag a person swept away in an avalanche. In this embodiment, the encircling element is loop 11 at the pouch end of tether 1. FIG. 5A is an exploded isometric view showing the elements of the device. Tether loop 11 is attached to flag 3, in this case by passing directly through an attachment opening 12 on the end of flag 3. The closure mechanism on pouch 4 is a snap 5. Pouch 4 also includes a carabiner 16 to attach the pouch to the base object, for example, a ski pole strap. Tether 1 then attaches, for example, to a skier's wrist via loop 22 at the distal end of tether 1.

FIG. 5B is an isometric view showing the device ready for use with flag 3 inserted in pouch 4, where pouch 4 is shown as transparent for clarity.

FIG. 5C is an isometric view of the embodiment of FIGS. 5A and 5B after flag 3 has been pulled from pouch 4. After snap 5 is pulled open by encircling tether loop 11, tether 1 pulls flag 3 out of pouch 4, and flag 3 unfurls as it exits pouch 4. Hence flag 3 in FIG. 5C is extended and available to flag the person to which it is tethered by loop 22. Pouch 4, in turn, remains attached to the object to which it is fastened (such as a ski pole), via carabiner 16 or the like.

Those skilled in the art will appreciate that the encircling elements, the elements used to connect flag 3 and tether 1, and the elements used to connect pouch 4 to a ski boot or other base object can be mixed and matched in a variety of ways, and that other elements not specifically shown and described could perform these functions. The pouch is shown as an elongated shape with the opening at a narrow end, but the pouch can be a variety of shapes and the end opening formed anywhere convenient. It will be appreciated by one skilled in the art that there are many possible variations on these designs that fall within the scope of the present invention.

What is claimed is:

1. A device for flagging an item to be located when the item is separated from a base object and is lost in the snow, the device comprising:
a pouch having an open end, the open end having a perimeter;
a fastening element configured for attaching the pouch to the base object;
a pouch closure mechanism configured to releasably join two spaced-apart areas on the perimeter of the open end;
an elongated flag configured for furling and insertion into the pouch, the flag having a connecting end and a loose end, the flag further configured to unfurl when released from the pouch;
an encircling element connected to the connecting end of the flag, the encircling element configured to encircle the pouch closure mechanism when joined; and
an attachment element configured for attaching the encircling element to the item to be located;
wherein the pouch closure mechanism is further configured to release when a sharp tug is applied to the encircling element by the item to be located, such that the flag is released from the pouch.

2. The device of claim 1, further comprising a tether attaching the encircling element to the item to be located.

3. The device of claim 1 wherein the closure mechanism comprises a snap closure.

4. The device of claim 1 wherein the closure mechanism comprises a hook-and-loop closure.

5. The device of claim 1 wherein the encircling element comprises one of the following:
a rigid ring,
a carabiner,
a spring hook, or
a flexible loop.

6. The device of claim 1 wherein the encircling element is threaded through a hole formed in the connecting end of the flag.

7. The device of claim 1 wherein the fastening element comprises a low-profile attachment loop.

8. The device of claim 1 wherein the item to be located is a person.

9. The device of claim 1 wherein the item to be located is a ski.

10. The device of claim 1 wherein the base object is a person.

11. The device of claim 1 wherein the base object is a ski pole.

12. The device of claim 1 wherein the flag is a brightly colored ribbon.

13. A method of flagging an item to be located when the item is separated from a base object and is lost in the snow comprising the steps of:
(a) providing a flagging unit having—
a pouch with an open end having a perimeter and a connection mechanism releasably joining two spaced-apart areas on the perimeter, and
an elongated flag inserted into the pouch, the flag having encircling element connected to an end of the flag,
wherein the encircling element encircles the connection mechanism;
(b) fastening the pouch to the base object;
(b) attaching the encircling element to the item to be located;
(c) pulling on the encircling element and releasing the connection mechanism;
(d) pulling the flag out from the pouch, and
(e) unfurling the flag.

14. The method of claim 13 wherein the fastening step fastens the pouch to a person.

15. The method of claim 13 wherein the fastening step fastens the pouch to a ski pole.

16. The method of claim 13 wherein the attaching step attaches the encircling element to a person.

17. The method of claim 13 wherein the attaching step attaches the encircling element to a ski.

18. A method of providing a flagging unit for flagging an item to be located when the item is separated from a base object and is lost in the snow comprising the steps of:
providing a pouch having an open end with a perimeter;
providing an elongated flag having an encircling element connected to an end of the flag,
inserting the flag into the pouch;
releasably joining two spaced-apart areas on the perimeter with a connection mechanism;
encircling the connection mechanism with the encircling element;
providing a fastener for fastening the pouch to the base object; and
providing an attachment for attaching the encircling element to the item to be located;
such that when the encircling element is tugged, the connection mechanism releases and the flag is pulled from the pouch and unfurls.
